(19) United States
(12) Patent Application Publication
(10) Pub. No.: US 2013/0148344 A1
(43) Pub. Date: Jun. 13, 2013

(54) LIGHT EMITTING DEVICE

(71) Applicants: Po-Jen Su, Tainan City (TW); Yun-Li Li, Tainan City (TW); Yi-Ju Shih, Tainan City (TW); Cheng-Yen Chen, Tainan City (TW); Gwo-Jiun Sheu, Tainan City (TW)

(72) Inventors: Po-Jen Su, Tainan City (TW); Yun-Li Li, Tainan City (TW); Yi-Ju Shih, Tainan City (TW); Cheng-Yen Chen, Tainan City (TW); Gwo-Jiun Sheu, Tainan City (TW)

(21) Appl. No.: 13/670,421

(22) Filed: Nov. 6, 2012

(30) Foreign Application Priority Data
Dec. 8, 2011 (TW) 100145331

(51) Int. Cl. F21V 9/00

(52) U.S. Cl. 362/231

(57) ABSTRACT

A light emitting device including an insulating substrate, a plurality of light emitting diode (LED) chips and a patterned conductive layer is provided. The insulating substrate has an upper surface. The LED chips are disposed on the insulating substrate and located on the upper surface. The dominant wavelengths of the LED chips are in a wavelength range of a specific color light and the dominant wavelengths of at least two of the LED chips are different. The patterned conductive layer is disposed between the insulating substrate and LED chips, and electrically connected to the LEDs chip.

### CROSS-REFERENCE TO RELATED APPLICATION

This application claims the priority benefit of Taiwan application serial no. 100145331, filed on Dec. 8, 2011. The entirety of the above-mentioned patent application is hereby incorporated by reference herein and made a part of this specification.

### BACKGROUND OF THE INVENTION

1. Field of the Invention

The invention relates to a light emitting device, and more particularly to a light emitting device employing a light emitting diode (LED) as a light source.

2. Description of Related Art

Thanks to numerous advantages of long life span, miniature size, high vibration and shock resistance, low heat emissivity, economical power consumption and so on, LEDs have been widely applied to indicating lights or light sources employed in a variety of household electric appliances and instruments. In recent years, the LED has been developed towards high power; therefore, its application scope has been expanded to road illumination, large outdoor display boards, traffic signal lights, and the like. In the future, the LED may even become the main illumination light source with both power-saving and environment-protecting functions.

Typically speaking, a large amount of heat is generated when a high power LED chip emits a high brightness light. If the heat cannot be dispersed and continues to accumulate in the LED chip, the temperature of the LED chip would rise persistently. Accordingly, due to overheating the LED chip may suffer reductions in brightness and lifespan, and in critical cases permanent damage may result in the LED chip. Moreover, in order to satisfy the needs of various industries, manufacturers typically produce LED chips of different size, voltage, emitting wavelength, or brightness. Due to the diverse nature of the manufacturing specifications, an inventory issue would likely occur for the LED chips, resulting in the increase of inventory costs.

### SUMMARY OF THE INVENTION

The invention provides a light emitting device employing a mixing of a plurality of chips to satisfy the needs of different wavelengths, voltages, or brightnesses.

The invention provides a light emitting device including an insulating substrate, a plurality of LED chips, and a patterned conductive layer. The insulating substrate has an upper surface. The LED chips are disposed on the insulating substrate and located on the upper surface. The dominant wavelengths of the LED chips are in a wavelength range of a specific color light, and the dominant wavelengths of at least two of the LED chips are different. The patterned conductive layer is disposed between the insulating substrate and the LED chips. The patterned conductive layer is electrically connected to the LED chips.

According to an embodiment of the invention, a difference between the dominant wavelengths of at least two of the LED chips is greater than or equal to 5 nm.

According to an embodiment of the invention, the LED chips are blue LED chips, and the specific color light is a blue light.

According to an embodiment of the invention, the range of the dominant wavelengths is between 430 nm to 490 nm.

According to an embodiment of the invention, the LED chips are green LED chips, and the specific color light is a green light.

According to an embodiment of the invention, the range of the dominant wavelengths is between 490 nm to 570 nm.

According to an embodiment of the invention, the LED chips are red LED chips, and the specific color light is red light.

According to an embodiment of the invention, the range of the dominant wavelengths is between 610 nm to 700 nm.

According to an embodiment of the invention, the patterned conductive layer is electrically connected to an external circuit.

According to an embodiment of the invention, the patterned conductive layer includes an inner connecting circuit and an outer connecting circuit. The inner connecting circuit is disposed correspondingly with the LED chips, and the LED chips are electrically connected in series and/or parallel with each other via the inner connecting circuit. The outer connecting circuit is disposed on an outer side of the inner connecting circuit, and the inner connecting circuit is electrically connected to the external circuit via the outer connecting circuit.

According to an embodiment of the invention, the light emitting device further includes at least a conductive connecting structure connected between the patterned conductive layer and the external circuit.

According to an embodiment of the invention, a specific heat of the insulating substrate is higher than 650 J/Kg-K.

According to an embodiment of the invention, a coefficient of thermal conductivity of the insulating substrate is greater than 10 W/m-K.

According to an embodiment of the invention, the insulating substrate is a transparent insulating substrate, and a material of the insulating substrate includes glass, gallium arsenide, silicon carbide, aluminum nitride, gallium nitride, or sapphire.

According to an embodiment of the invention, the LED chips include flip chip LED chips.

According to an embodiment of the invention, the patterned conductive layer is embedded in the upper surface of the insulating substrate.

According to an embodiment of the invention, the patterned conductive layer is disposed on the upper surface of the insulating substrate.

In summary, an embodiment the invention disposes LED chips on the insulating substrate emitting the same specific color light, and the dominant wavelengths of at least two of the LED chips are different. Moreover, by mixing high brightness chips with low brightness chips, a light emitting device having a uniform brightness can be achieved. Similarly, the technique can be applied in wavelength mixing, in which a light emitting device having a uniform brightness is achieved by using chips of long wavelengths with chips of short wavelength, thereby satisfying the various needs from a client. Moreover, since an embodiment of the invention adopts the insulating substrate as the carrier plate for the LED chips, therefore, the heat generated by the LED chips can be effectively transferred and contained in the insulating substrate, so as to mitigate the issue of reduced light emitting efficiency due to heat accumulation in the LED chips.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic perspective view of a light emitting device according to an embodiment of the invention.

FIG. 1B is a schematic cross-sectional view taken along a line I-I in FIG. 1A.

FIG. 1C is a top view of a light emitting device according to an embodiment of the invention.

FIG. 1D is a schematic cross-sectional view of a light emitting device according to another embodiment of the invention.

FIG. 2 is a schematic perspective view of a light emitting device according to an embodiment of the invention.

FIG. 3 is a schematic perspective view of a light emitting device according to an embodiment of the invention.

### DESCRIPTION OF EMBODIMENTS

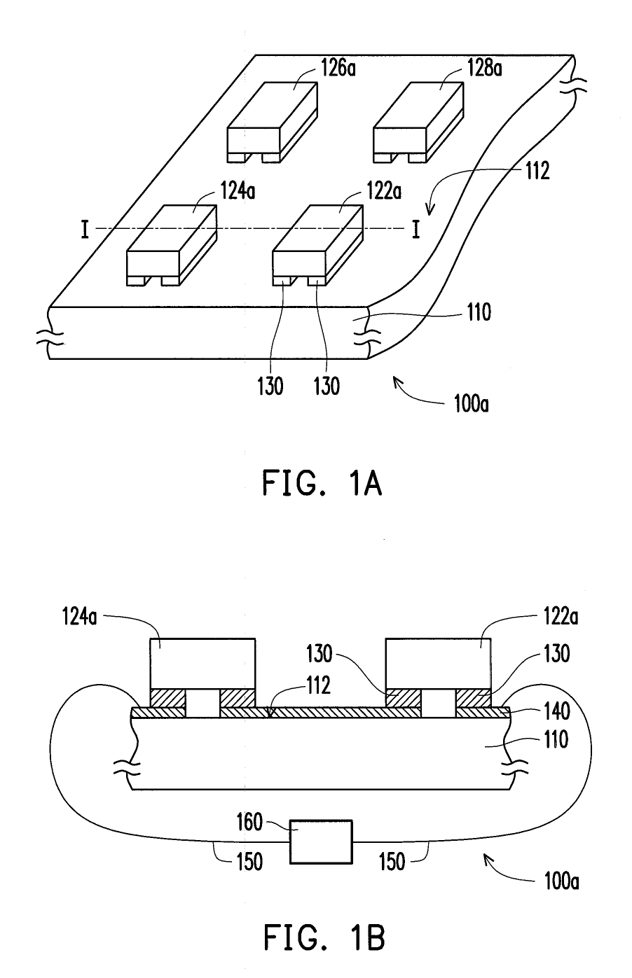

FIG. 1A is a schematic perspective view of a light emitting device according to an embodiment of the invention. FIG. 1B is a schematic cross-sectional view taken along a line I-I in FIG. 1A. In order to facilitate description, the patterned conductive layer, the conductive connecting structures, and the external circuit are omitted in FIG. 1A. Referring to FIGS. 1A and 1B, in the present embodiment, a light emitting device 100a includes an insulating substrate 110, a plurality of LED chips 122a, 124a, 126a, and 128a (only four are schematically depicted in FIG. 1A), and a patterned conductive layer 140.

Specifically, in order for the insulating substrate 110 to contain the heat generated by the LED chips 122a, 124a, 126a, and 128a during the light emitting process, and to mitigate the issue of reduced light emitting efficiency generated due to heat accumulation in the LED chips 122a, 124a, 126a, and 128a, a specific heat of the insulating substrate 110 needs to be higher than 650 J/Kg-K. Alternatively, by having a coefficient of thermal conductivity of the insulating substrate be higher than 10 W/m-K, heat accumulated in the LED chips 122a, 124a, 126a, and 128a can be rapidly transferred outwards. Moreover, in order to increase the light extraction efficiency, it is necessary to prevent absorption of the light emitted from a light emitting layer 123b by the substrate. Therefore, the insulating substrate 110 is a transparent insulating substrate. For example, the insulating substrate 110 may be a glass substrate, a gallium arsenide substrate, a gallium nitride substrate, an aluminum nitride substrate, a sapphire substrate, a silicon carbide substrates, etc. Preferably, the insulating substrate is a sapphire substrate. The LED chips 122a, 124a, 126a, and 128a are disposed on the insulating substrate 110 and located on an upper surface 112. The LED chips 122a, 124a, 126a, and 128a are, for example, flip chip LED chips. The patterned conductive layer 140 is disposed between the insulating substrate 110 and the LED chips 122a, 124a, 126a, and 128a and electrically connected to the LED chips 122a, 124a, 126a, and 128a. In specific, the patterned conductive layer 140 is disposed on the upper surface 112 of the insulating substrate 110, and the LED chips 122a, 124a, 126a, and 128a electrically connect to the patterned conductive layer 140 located on the insulating substrate 110 via a plurality of conductive contacts 130. Referring to FIG. 1C, a top view of a light emitting device according to an embodiment of the invention is illustrated in FIG. 1C. In order to facilitate description, the LED chips, the conductive connecting structures, and the external circuit are omitted in FIG. 1C. The patterned conductive layer 140 is disposed on the upper surface 112 of the insulating substrate 110. The patterned conductive layer 140 includes an inner connecting circuit 142 and an outer connecting circuit 144. The inner connecting circuit 142 may connect the LED chips in series and/or parallel with each other (series connection is schematically depicted in FIG. 1C). The outer connecting circuit 144 is disposed on an outer side of the inner connecting circuit 142 in order to electrically connect to an external circuit. In particular, the dominant wavelengths of the LED chips 122a, 124a, 126a, and 128a of the present embodiment are in a wavelength range of a specific color light, and the dominant wavelengths of at least two of the LED chips 122a and 124a are different.

Specifically, the LED chips 122a, 124a, 126a, and 128a of the present embodiment are blue LED chips, the specific color light is a blue light, and the range of the dominant wavelengths is, for example, between 430 nm to 490 nm. Particularly, a difference between the dominant wavelengths of the LED chip 122a and the LED chip 124a is greater than or equal to 5 nm. For example, the dominant wavelength of the LED chip 122a is 450 nm, and the dominant wavelength of the LED chip 124a is 470 nm. However, the dominant wavelengths of the LED chips 126a and 128a may be the same or different as the dominant wavelengths of the LED chip 122a or LED chip 124a, and the invention is not limited thereto. In an illustrative example, the dominant wavelengths of the LED chips 126a and 128a are taken to be different from the dominant wavelength of the LED chip 122a and the dominant wavelength of the LED chip 124a. The dominant wavelengths of the LED chips 126a and 128a are, for example, 460 nm.

Moreover, in order to enhance the applicability of the light emitting device 100a, the patterned conductive layer 140 may be electrically connected to an external circuit 160. Specifically, in the present embodiment, the light emitting device 100a may further include at least a conductive connecting structure 150 (two are schematically illustrated in FIG. 1B), in which the conductive connecting structures 150 are connected between the patterned conductive layer 140 and the external circuit 160. The external circuit 160 may be, for example, a lead frame, a circuit substrate, or a printed circuit board.

In the light emitting device 100a of the present embodiment, since the LED chips 122a, 124a, 126a, and 128a emitting the same blue light and having the same and similar dominant wavelengths are disposed on the insulating substrate 110, therefore, after the blue light emitted from the LED chips 122a, 124a, 126a, and 128a are mixed with each other, a blue light having an average wavelength of 460 nm (i.e., (450+470+460+460)/4=460) can be obtained. Accordingly, the light emitting device 100a can exhibit uniform brightness performance. Consequently, the inventory issue for the conventional LED chips can be resolved, thereby lowering the inventory costs. Moreover, since the present embodiment adopts the insulating substrate 110 as a carrier plate for the LED chips 122a, 124a, 126a, and 128a, therefore, not only the heat generated by the LED chips 122a, 124a, 126a, and 128a can be effectively transferred to external surroundings to enhance the heat dissipation effect of the light emitting device 100a, but the light absorption issue can also be mitigated to increase the luminance of the light emitting device 100a. Moreover, the LED chips 122a, 124a, 126a, and 128a of the present embodiment are flip chip LED chips. Therefore, compared to conventional methods of wire bonding to electrically connect the LED chips and the patterned conductive layer, the present embodiment can effectively reduce the thickness and size of the light emitting device 100a.

It should be noted that, the invention is not limited by the disposition position of the patterned conductive layer 140, although in the disclosure the patterned conductive layer 140 is disposed on the upper surface 112 of the insulating substrate 110 as an illustrative example. However, in other embodiments, referring to FIG. 1D, a patterned conductive layer 140′ may be embedded in the upper surface 112 of the insulating substrate 110. Accordingly, the thickness of a light emitting device 100a′ can be effectively reduced to satisfy the current developmental trend of thinness.

It should be noted that, the embodiments described hereafter employ the reference labels and a portion of the technical content in the afore-described embodiment, and same or similar reference labels are used to represent the same or the like elements. Moreover, description of the same technical content is omitted. The omitted portion of the description can be referred to the afore-described embodiment, and therefore is not repeated herein.

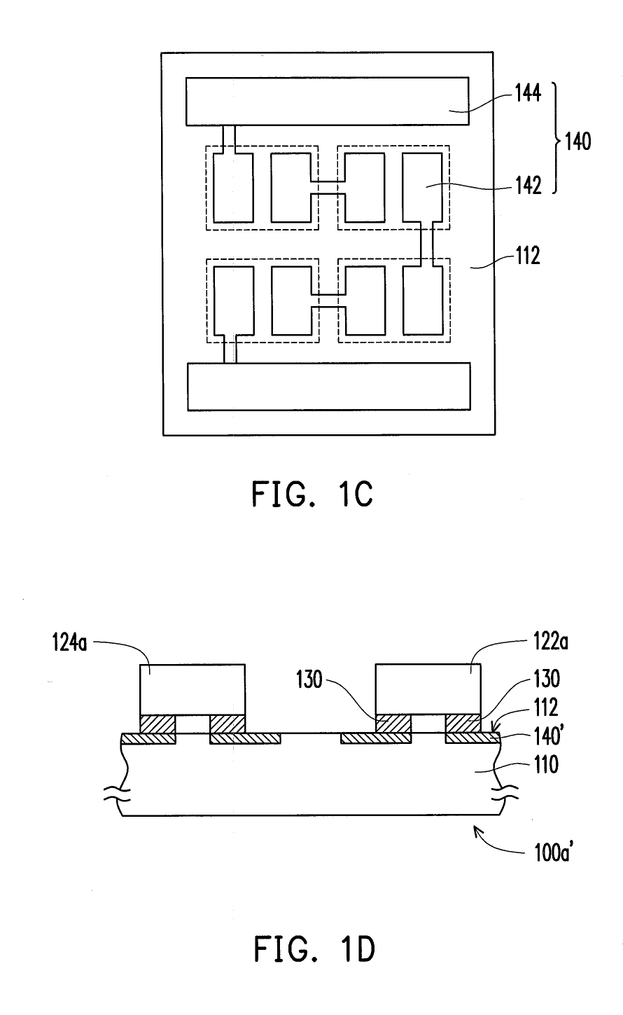

FIG. 2 is a schematic perspective view of a light emitting device according to an embodiment of the invention. Referring to FIG. 2, a light emitting device 100b of the present embodiment is similar to the light emitting device 100a depicted in FIG. 1A. A difference between the two lies in that, the LED chips 122b, 124b, 126b, and 128b of the light emitting device 100b are green LED chips, the specific color light is a green light, and the range of the dominant wavelengths is greater than or equal to 490 nm and less than 570 nm.

In the present embodiment, the dominant wavelengths of the LED chips 122b, 124b, 126b, and 128b are different from each other. The dominant wavelengths of the LED chips 122b, 124b, 126b, and 128b are, for example, 500 nm, 530 nm, 550 nm, and 570 nm, in sequence. A difference between the highest dominant wavelength (i.e. 570 nm) of the LED chip 128b and the lowest dominant wavelength (i.e. 500 nm) of the LED chip 122b is equal to 70 nm.

In the light emitting device 100b of the present embodiment, since the LED chips 122b, 124b, 126b, and 128b emitting the same green light and having different dominant wavelengths are disposed on the insulating substrate 110, therefore, after the green light emitted from the LED chips 122b, 124b, 126b, and 128b are mixed with each other, a green light having an average wavelength of 537.5 nm (i.e., (500+530+550+570)/4=537.5) can be obtained. Accordingly, the light emitting device 100b can exhibit uniform brightness performance. Consequently, by adopting LED chips 122b and 128b having a large difference (e.g. 70 nm) in the dominant wavelengths thereof, the inventory issue for the conventional LED chips can be resolved, thereby lowering the inventory costs.

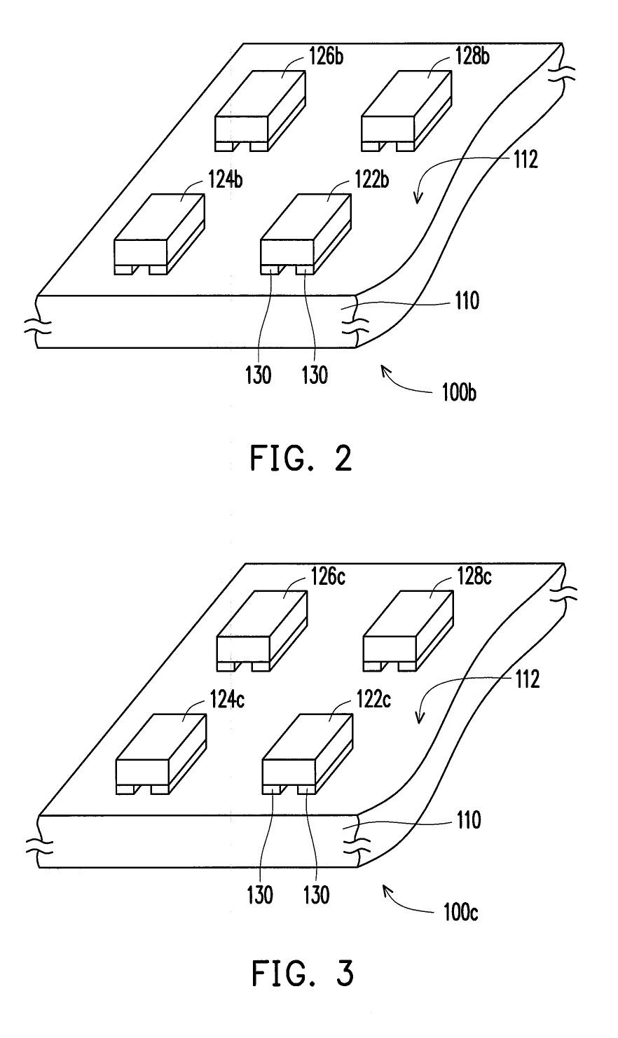

FIG. 3 is a schematic perspective view of a light emitting device according to an embodiment of the invention. Referring to FIG. 3, a light emitting device 100c of the present embodiment is similar to the light emitting device 100a depicted in FIG. 1A. A difference between the two lies in that, the LED chips 122c, 124c, 126c, and 128c of the light emitting device 100c are red LED chips, the specific color light is a red light, and the range of the dominant wavelengths is greater than or equal to 610 nm and less than 700 nm.

In the present embodiment, the dominant wavelengths of the LED chips 122c, 124c, 126c, and 128c are different from each other. The dominant wavelengths of the LED chips 122c, 124c, 126c, and 128c are, for example, 641 nm, 643 nm, 645 nm, and 647 nm, in sequence. A difference between the highest dominant wavelength (i.e. 647 nm) of the LED chip 128c and the lowest dominant wavelength (i.e. 641 nm) of the LED chip 122c is equal to 6 nm.

In the light emitting device 100c of the present embodiment, since the LED chips 122c, 124c, 126c, and 128c emitting the same red light and having similar dominant wavelengths are disposed on the insulating substrate 110, therefore, after the red light emitted from the LED chips 122c, 124c, 126c, and 128c are mixed with each other, a red light having an average wavelength of approximately 644 nm (i.e., (641+643+645+647)/4=644) can be obtained. Accordingly, the light emitting device 100c can exhibit uniform brightness performance. Consequently, by adopting LED chips 122c, 124c, 126c, and 128c having similar dominant wavelengths, the inventory issue for the conventional LED chips can be resolved, thereby lowering the inventory costs.

Besides, in other embodiments not illustrated, persons ordinarily skilled in the art can refer to the description of the previous embodiments, and achieve the needed technical effects by consulting the previous arrangements according to actual requirements.

In view of the foregoing, an embodiment the invention disposes LED chips on the insulating substrate emitting the same specific color light, and the dominant wavelengths of at least two of the LED chips are different. Moreover, by mixing high brightness chips with low brightness chips, a light emitting device having a uniform brightness can be achieved, and the need for various wavelengths from a client can be satisfied. At the same time, the inventory issue for the LED chips can be mitigated, thereby effectively lowering the inventory costs. Moreover, since an embodiment of the invention adopts the insulating substrate as the carrier plate for the LED chips, therefore, not only the heat generated by the LED chips can be effectively transferred to external surroundings to enhance the heat dissipation effect of the light emitting device, but the light absorption issue can also be mitigated to increase the luminance of the light emitting device. Moreover, an embodiment of the invention adopts flip chip LED chips to serve as the light emitting sources. Therefore, the light emitting device in the invention has a reduced thickness and size.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A light emitting device, comprising:
an insulating substrate having an upper surface;
a plurality of light emitting diode (LED) chips disposed on the insulating substrate and located on the upper surface, wherein the dominant wavelengths of the LED chips are in a wavelength range of a specific color light, and the dominant wavelengths of at least two of the LED chips are different; and
a patterned conductive layer disposed between the insulating substrate and the LED chips and electrically connected to the LED chips.

2. The light emitting device as claimed in claim 1, wherein a difference between the dominant wavelengths of at least two of the LED chips is greater than or equal to 5 nm.

3. The light emitting device as claimed in claim 1, wherein the LED chips are blue LED chips, and the specific color light is a blue light.

4. The light emitting device as claimed in claim 3, wherein the range of the dominant wavelengths is greater than or equal to 430 nm and less than 490 nm.

5. The light emitting device as claimed in claim 1, wherein the LED chips are green LED chips, and the specific color light is a green light.

6. The light emitting device as claimed in claim 5, wherein the range of the dominant wavelengths is greater than or equal to 490 nm and less than 570 nm.

7. The light emitting device as claimed in claim 1, wherein the LED chips are red LED chips, and the specific color light is a red light.

8. The light emitting device as claimed in claim 7, wherein the range of the dominant wavelengths is greater than or equal to 610 nm and less than 700 nm.

9. The light emitting device as claimed in claim 1, wherein the patterned conductive layer comprises:
an inner connecting circuit disposed correspondingly with the LED chips, the LED chips being electrically connected with each other via the inner connecting circuit; and
an outer connecting circuit disposed on an outer side of the inner connecting circuit.

10. The light emitting device as claimed in claim 1, wherein the patterned conductive layer is electrically connected to an external circuit.

11. The light emitting device as claimed in claim 10, further comprising at least a conductive connecting structure connected between the patterned conductive layer and the external circuit.

12. The light emitting device as claimed in claim 1, wherein a specific heat of the insulating substrate is higher than 650 J/Kg-K.

13. The light emitting device as claimed in claim 1, wherein a coefficient of thermal conductivity of the insulating substrate is greater than 10 W/m-K.

14. The light emitting device as claimed in claim 1, wherein the insulating substrate is a transparent insulating substrate.

15. The light emitting device as claimed in claim 14, wherein the transparent insulating substrate is a sapphire substrate.

16. The light emitting device as claimed in claim 1, wherein the light emitting chips comprise a flip chip LED chips.

17. The light emitting device as claimed in claim 1, wherein the patterned conductive layer is embedded in the upper surface of the insulating substrate.

18. The light emitting device as claimed in claim 1, wherein the patterned conductive layer is disposed on the upper surface of the insulating substrate.
